(19) United States
(12) Patent Application Publication
(10) Pub. No.: US 2005/0027571 A1
(43) Pub. Date: Feb. 3, 2005

(54) Method and apparatus for risk assessment for a disaster recovery process

(75) Inventors: David Gamarnik, New York, NY (US); Jonathan R. M. Hosking, Scarsdale, NY (US); William F. Kane, Florida, NY (US); Ta-Hsin Li, Danbury, CT (US); Emmanuel Yashchin, Yorktown Heights, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/629,869

(22) Filed: Jul. 30, 2003

(51) Int. Cl. G01V 3/00; G01V 7/00; G06F 19/00; G06F 17/60

(52) U.S. Cl. 705/4; 702/2

(57) ABSTRACT

A method and structure for calculating a risk exposure for a disaster recovery process, including loading a user interface into a memory, the user interface allowing control of an execution of one or more risk models. Each risk model is based on a specific disaster type, and each risk model addresses a recovery utilization of one or more specific assets identified as necessary for a recovery process of the disaster type. One of the risk models is executed at least one time.

### BACKGROUND OF THE INVENTION

1. Field of the Invention

The present invention generally relates to a tool designed for strategic risk management. More specifically, a tool provides an objective method to estimate the likely demands from customers on resources of a disaster recovery service.

2. Description of the Related Art

In the age of information technology, computers are becoming increasingly critical to many businesses, ranging from financial institutions to on-line stores. For these businesses, uninterrupted computer service is a key to their normal operations. Rapid recovery from computer service interruptions caused by natural disasters, such as earthquakes, hurricanes, and floods, also has tremendous benefits to the businesses.

A “disaster recovery service” is a business that provides computer facilities to contracted customers who seek recovery services in the aftermath of disasters or in anticipation of disasters. The success of a disaster recovery service depends crucially on the assessment of risks associated with a given pool of customers for the given computer assets of the disaster recovery operation in the event of different disasters. While under-commitment results in wasted resources, over-commitment leads to not being able to provide services to customers who demand recovery according to the contract.

To assess the risks of its operations, the disaster recovery service needs to estimate the likelihood that the inventory for any resource may be insufficient, resulting in failure to recover a customer. This requires an estimate of the maximum probable demand for each resource over some planning horizon.

Additionally, when setting prices for its contracts, a disaster recovery service needs to estimate the likely demands that any given customer or potential customer may make on the disaster recovery service's resources. This process requires an estimate of the frequency with which the customer may be expected to declare a disaster.

No systematic and objective procedure for making these estimates is currently available.

### SUMMARY OF THE INVENTION

In view of the foregoing problems, drawbacks, and disadvantages of the conventional systems, it is a purpose of the present invention to provide a structure (and method) for estimating the risks associated with disaster recovery.

More specifically, the present invention provides an objective criteria by which the business may:
set inventory levels at its recovery centers;
plan the location of its recovery centers;
decide whether anticipated changes in the rates of occurrence of disaster events will adversely affect the business;
judge whether its current resources are sufficient to deal with an anticipated increase in the number of customers;
judge whether it current resources are sufficient to deal with a specific (actual or potential) disaster event; and/or
decide whether individual (actual or potential) contracts are profitable.

It is another purpose of the present invention to provide a method allowing a disaster recovery business to improve its ability to manage disaster events, thereby leading to greater levels of customer satisfaction.

It is still another purpose of the present invention to provide a competitive advantage to a business by allowing it to advertise that has access to a systemic and objective method for risk estimation.

It is still another purpose of the present invention to provide a method that may be applied to any operation that is subject to interruption by external events and for which the reaction to those events is not predetermined. It is noted that “reaction not predetermined” distinguishes the present invention from superficially similar applications in insurance, wherein the reaction to a valid claim by the customer is typically a fixed payout.

Such operations may include banks or other financial institutions, businesses with manufacturing operations in several locations spread across the country, and any business or federal agency with data-processing operations in several locations spread across the country.

The present invention consists of three procedures (“specifications”) and their associated apparatus (“tools”), that singly or together provide assessments of different aspects of the risks associated with disaster recovery services.

In a first aspect, the present invention teaches a method (and a structure and a network) of calculating a risk exposure for a disaster recovery, including loading a user interface into a memory, the interface allowing control of an execution of one or more risk models, each risk model based on a specific disaster type, each risk model addressing a recovery utilization of one or more specific assets identified as necessary for a recovery process of the disaster type. One of the risk models is executed at least one time.

In a second aspect, the present invention teaches a signal-bearing medium tangibly embodying a program of machine-readable instructions executable by a digital processing apparatus to perform the above-described method of calculating a risk exposure for a disaster recovery process.

In a third aspect, the present invention teaches a method (and a signal-bearing medium tangibly embodying a program) of objectively quantifying consequences of an event, including loading one or more models concerning the event into a memory, at least one of the models predicting a consequence of the event, as based on an historical data of the event. At least one of the risk models is executed a plurality of times, each time using at least one parameter that is selected at random. A result of the executing is used to quantify a probability of a consequence of the event.

In a fourth aspect, the present invention teaches a method of operating a disaster recovery service, including acquiring access to a tool that calculates a risk exposure for a disaster recovery process and advertising that the disaster recovery service utilizes this tool as a technique to control an inventory of assets for disaster recovery.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an exemplary introduction screen 100 for a Graphic User Interface (GUI) of a preferred embodiment of the present invention;

FIG. 2 shows a model of operation 200 for a disaster recovery service;

FIG. 3 demonstrates an exemplary simulation 300 of the Overall Risk Exposure tool of a preferred embodiment;

FIG. 4 shows an exemplary GUI screen 400 for the Overall Risk Exposure tool;

FIG. 5 shows an exemplary graphical result screen 500 for an Overall Risk Exposure simulation;

FIGS. 6 and 6A shows a flowchart 600 of the operation of the Overall Risk Exposure tool;

FIG. 7 shows an exemplary GUI screen 700 for the Disaster Outlook tool;

FIGS. 8 and 8A shows a flowchart 800 of the operation of the Disaster Outlook tool;

FIG. 9 shows an exemplary graphical result screen 900 for a Disaster Outlook simulation;

FIG. 10 shows an exemplary GUI screen 1000 for the Customer Risk Assessment tool;

FIG. 11 shows an exemplary flowchart 1100 for operation of the Customer Risk Assessment Tool;

FIG. 12 shows a method of operation 1200 in which a disaster recovery service could benefit from the present invention;

FIG. 13 shows graphical data for an exemplary earthquake model;

FIG. 14 shows curve fitting for the earthquake model;

FIG. 15 shows graphical data for an exemplary flood model;

FIG. 16 illustrates an exemplary hardware/information handling system 1600 for incorporating the present invention therein; and

FIG. 17 illustrates a signal bearing medium 1700 (e.g., storage medium) for storing steps of a program of a method according to the present invention.

### DETAILED DESCRIPTION OF A PREFERRED EMBODIMENT OF THE INVENTION

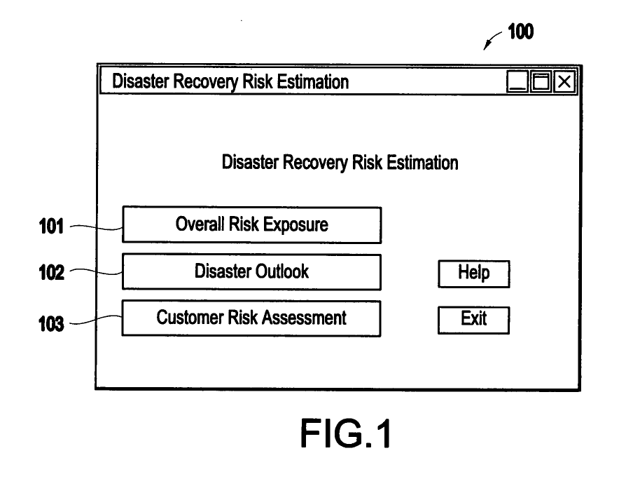

Referring now to the drawings, and more particularly to FIGS. 1-17, a preferred embodiment will now be described as implemented for a disaster recovery service tool.

Although this exemplary embodiment specifically addresses disaster recovery service, the present invention is not intended as being limited to this specific application, since it provides results that could be used in other applications. As possible examples, the present invention might be used as a risk assessment tool for insurance, as assessment for disaster readiness by a government or a company. For example, a power company might use the present tool to access its capability to guarantee power to specific customers under various disaster scenarios.

Nor is the present invention intended as being limited to “risk” or to “disaster” scenarios, since any “event” having a historical data file potentially could be modeled by the present invention.

FIG. 1 shows an introductory screen 100 of the Graphic User Interface (GUI) of a preferred embodiment using the present invention as a disaster recovery service tool. Three tools, the Overall Risk Exposure tool 101, the Disaster Outlook tool 102, and the Customer Risk Assessment tool 103 are accessible from this introductory screen 100.

The Overall Risk Exposure tool 101 is designed for strategic risk management. It provides answers for questions such as “Over the next year, what is the maximum number of customers who will require disaster recovery at the same time?”

This information can be used to assess the risk that the disaster recovery service's resources will not be adequate, resulting in a failure to recover a customer that has declared a disaster. It can also be used to judge the level of resources that must be maintained in order to have confidence that such a failure-to-recover situation will not occur.

The Disaster Outlook tool 102 is designed for short-term risk forecasting and resource management. It can provide predictions of the likely consequences of a recent or anticipated disaster event. For example, if a hurricane is approaching the east coast, this tool can provide an answer to questions such as “if this hurricane makes landfall near ZIP code 28403 (Wilmington, N.C.), how many customer declarations are likely to result from this hurricane?” This answer enables judgment of the level of resources necessary to cope with a specified disaster event.

The Customer Risk Assessment tool 103 provides targeted risk assessment for individual customers. It estimates how frequently, on average, a given (actual or potential) customer will declare a disaster. This information can be used, for example, to judge the profitability of particular contracts.

The Disaster Recovery Service Business Model

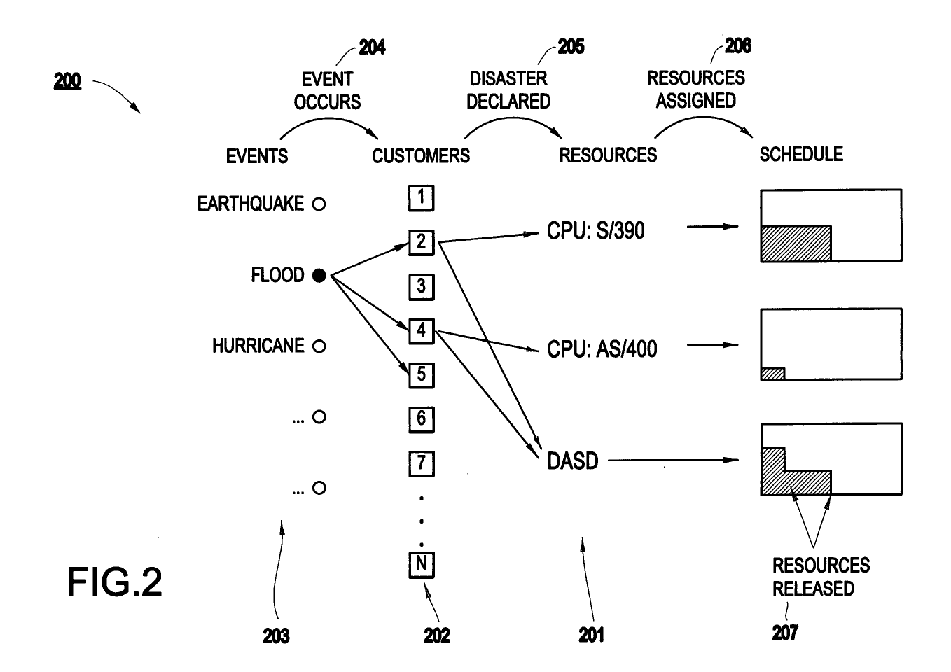

The invention uses the abstraction 200 illustrated in FIG. 2 for operations of a disaster recovery service.

The exemplary disaster recovery service maintains a set of resources 201 available for its customers 202 to use. Examples of resources might include, for example, CPUs of different kinds, tape drives, disk storage capacity and network bandwidth. Each resource has an attribute “inventory”, which is the quantity of that resource which is available for customers to use. Each resource also has a state “current utilization”, which is the quantity of the resource that is currently being used by customers recovering from disasters. That is, “current utilization” is a number between zero and the “inventory” number.

Customers of the disaster recovery service have contracts that enable them to make use of the disaster recovery service's resources if the customer “declares” that it is affected by a disaster event 203. Each customer has attributes such as “resource requirements”, i.e., the quantity of each resource to which the customer's contract guarantees access, and “location”, i.e., the physical location of the equipment covered by the contract, and perhaps others such as an “industry class”. It should be apparent that any property of the customer that may affect the customer's exposure to disaster events or the customer's propensity to declare once a disaster event has occurred is a potentially relevant attribute.

Each customer also has a state “declaration status” which is either “declared”, meaning that the customer has declared a disaster and is using or expects to use the disaster recovery service's resources, or “not declared”, meaning that the customer is not currently affected by a disaster event.

Disaster events 203 each have attributes, such as the following:

“Type”: the type of event, e.g. hurricane, flood, fire, CPU failure, terrorist attack.
“Time”: the time at which the event occurred.
“Location”: the point at which the event occurred, or the area affected by the event, depending on which type of event it is.
“Severity”: a measure of the magnitude of the event.

It should be apparent that other attributes are possible. That is, any property of the event that may affect the number of customers who declare as a result of the event is a potentially relevant attribute. Disaster types may be classified as “regional”, meaning that it potentially affects more than one customer, e.g., a hurricane, or “local”, meaning that it affects only one customer, e.g., a CPU failure.

When a disaster event occurs (204), customers that are affected by the disaster declare a disaster (205), perhaps after some lapse of time, and start using the disaster recovery service's resources (206). A customer that declares will, after some period of time, “release” the resources (207), making them available for other customers, and resume operations at its own location. This process creates, over time, a pattern of successive increases and decreases in the level of utilization of each resource.

The objectives of the disaster recovery service are to maintain a satisfactory level of service and to ensure profitability of its operations. An ideal level of service is that there should never be a failure to recover a customer, i.e., when a customer declares, the sum of the customer's resource requirements and the current utilization should never exceed the inventory level for any resource.

Risk Assessment for a Disaster Recovery Business

To assess the risks of its operations, the disaster recovery service needs to estimate the likelihood that the inventory for any resource may be insufficient, resulting in failure to recover a customer. This requires an estimate of the maximum probable demand for each resource over some span of time, referred to as a planning horizon.

Additionally, when setting prices for its contracts, the disaster recovery service needs to estimate the likely demands that any given customer or potential customer may make on the disaster recovery service's resources. This requires an estimate of the frequency with which the customer may be expected to declare a disaster.

The preferred embodiment of the present invention provides a systematic and objective procedure for making these estimates and exemplarily includes the following six primary components:
(1) A specification of the frequency and patterns of occurrence of each type of disaster event;
(2) A specification of the relation between the occurrence of a disaster event and the number of customer declarations that it causes;
(3) A specification of the pattern of times of declaration and release for customer declarations;
(4) The “Overall Risk Exposure tool”;
(5) The “Disaster Outlook tool”; and
(6) The “Customer Risk Assessment tool”.
   1. Specification of the Frequency and Patterns of Occurrence of Each Type of Disaster Event

In the preferred embodiment, this takes the form of statistical models that describe the frequency of occurrence and the values of the “location” and “severity” attributes of each type of disaster event.

2. Specification of the Relation Between the Occurrence of a Disaster Event and the Number of Customer Declarations that It Causes

In the preferred embodiment, this takes the form of statistical models that describe the probability that a customer declares a disaster given the attributes of the customer and the attributes of the disaster event.

3. Specification of the Pattern of Times of Declaration and Release for Customer Declarations

In the preferred embodiment, this takes the form of two statistical models: one that describes the time lag between the disaster event's ‘time” and the time of the customer declaration, and one that describes the time lag between the customer's declaration and its release of resources. The time lags are specified as probability distributions that may depend on the attributes of the customer and the attributes of the disaster event.

The statistical models in the three above-identified specifications are constructed so that they accurately reflect the real-world patterns of occurrence of disaster events. This is achieved by calibrating the models on historical data of event occurrence, or on the disaster recovery service's own history of disaster declarations by its customers. Data to develop a statistical model for each type of disaster is typically: available from various sources and examples are discussed later for this exemplary preferred embodiment.

4. The Overall Risk Exposure Tool

This tool is a procedure and apparatus that computes risk estimates for the overall operation of the disaster recovery service. That is, it models the maximum number of simultaneous recoveries requested over a specified time horizon. The tool computes the exposure of a disaster recovery service to risks related to different types of disaster events, for example, hurricanes, earthquakes, floods, power outages, and tornadoes.

This tool is designed to answer questions such as “Over the next year, what is the maximum number of customers who will require disaster recovery at the same time?”. Its application includes strategic risk management and setting inventory levels.

Because disaster events occur irregularly and neither they nor customers' reactions to them can be accurately predicted, the question can only be answered in probabilistic terms, e.g. “The maximum number of simultaneous recoveries will exceed 30 with probability 17%”. The tool's output is therefore expressed as a set of tables that give the exceedance probabilities for different numbers of recoveries and resource levels.

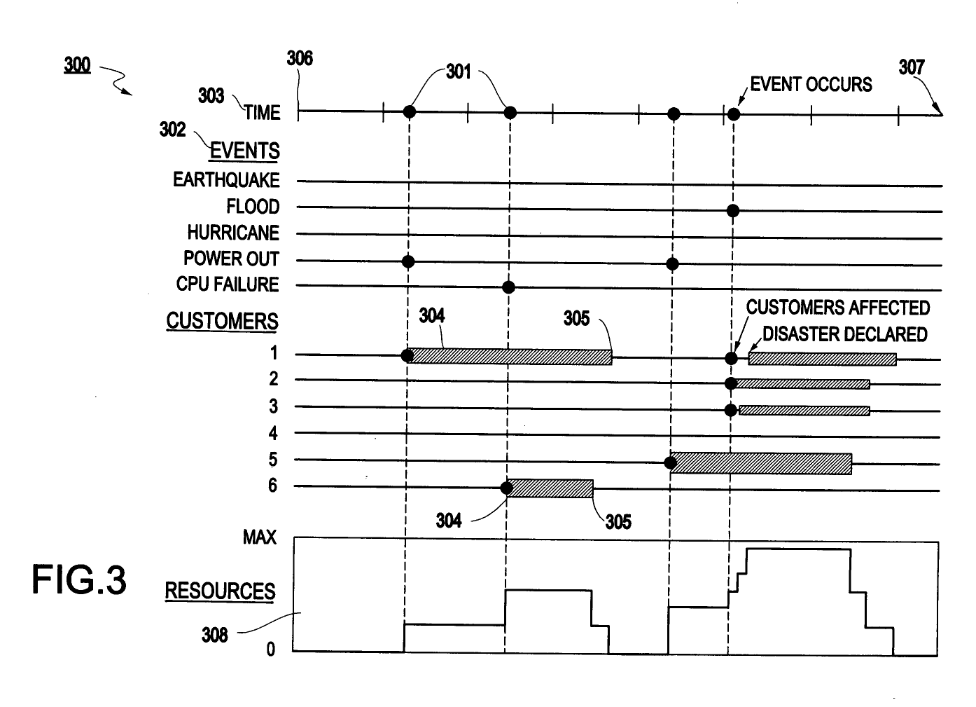

As shown in FIG. 3, the Overall Risk Exposure Tool uses a simulation approach 300. That is, this tool simulates the occurrence 301 of disaster events 302 over time 303, along with customers' consequent declarations 304 of disasters and releases 305 of resources. The tool uses a simulated time that starts at “now” 306 and continues until a time horizon 307 chosen by the user.

As the simulation progresses, the tool keeps track 308 of the maximum number of customers with simultaneously active declarations, and the maximum utilization of each resource. A single simulation run computes one number for each resource, the maximum demand for that resource at any time during the simulation period: this is one possible scenario of future resource requirements.

The procedure is repeated for many runs, thereby building up the probability distribution of maximum resource requirements and enabling the estimation of exceedance probabilities. Specifically, the exceedance probability for, say, 30 simultaneous recoveries is computed as (the number of simulation runs in which the maximum number of simultaneous recoveries was greater than 30) divided by (the total number of simulation runs).

Because the simulation procedure has built-in randomness, the final exceedance probabilities are not exact. The accuracy of the probabilities can be improved by increasing the number of simulation runs, but at the cost of increased computing time. This randomness also means that using the tool more than once with the same input parameters may produce different values for the exceedance probabilities. However, the differences should usually be no larger than the accuracy values given in the tool's output.

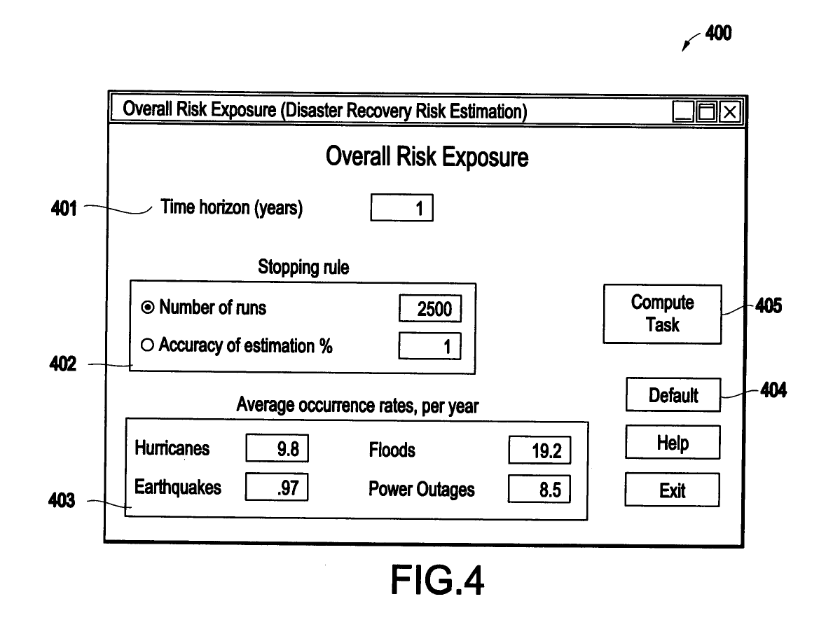

FIG. 4 shows an exemplary GUI screen 400 for the Overall Risk Exposure tool. The user would typically set up the tool settings by entering a horizon time 401, selecting a stopping rule 402, and entering the annual average occurrence rate for disasters 403 (or, select the default value 404), and then activate the “compute risk” command 405.

The exemplary Overall Risk Exposure tool computes the exposure of resources to risks related to only four types of disaster events, hurricanes, earthquakes, floods and power outages. Although these four disaster types historically account for the vast majority of situations in which more than one customer simultaneously needs disaster recovery, there is no reason to limit this tool to these four disaster types. Other possible natural disaster might include, for example, tornados, hail, and lightning. Nor are “events” necessarily caused by nature, since terrorism, crime, labor disputes, or equipment failure such as CPU failure, could also be included as events for risk assessment.

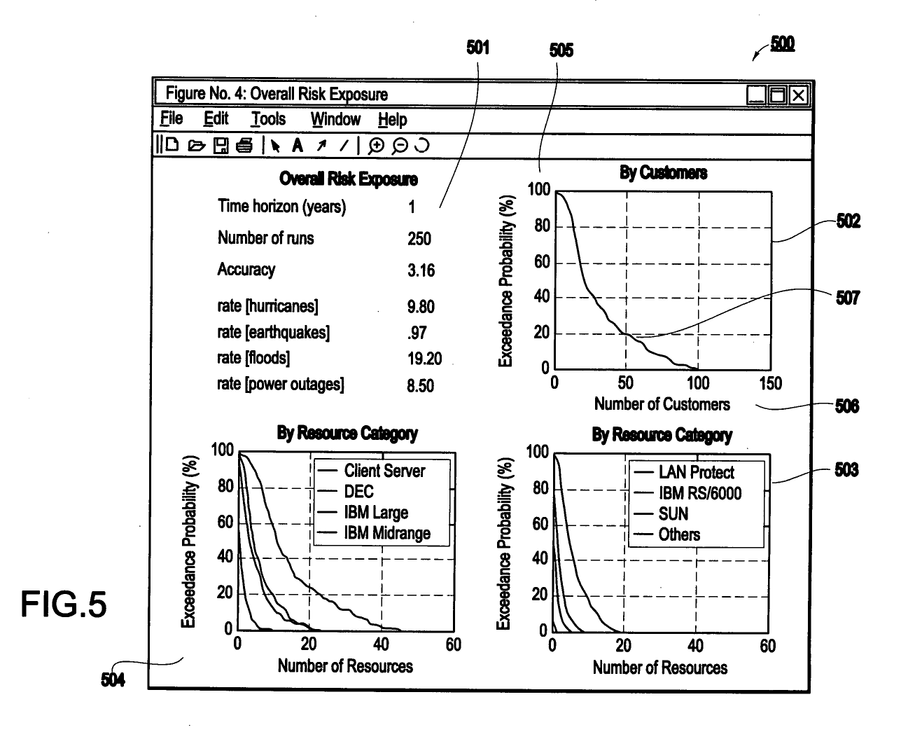

FIG. 5 exemplarily shows the simulation result display 500 for the Overall Risk Exposure tool in a graphical format. The setup conditions 501 are displayed in the upper left of the display 500. The simulation results are shown in charts 502, 503, 504 that indicate the exceedance probability (vertical axis) for number of customers 502 and resource categories 503, 504. Taking the customer chart 502 as an example, these charts indicate the probability 505 that a specific number of customers 506 made a declaration.

For example, point 507 indicates that on 20% of the simulation runs, at least approximately 50 customers had declarations active at the same time. That is, if point 507 is plotted at a horizontal axis value of 50 and a vertical axis value of 20, this means that, over the time horizon specified in the input parameters, the probability that more than 50 customers will simultaneously require disaster recovery is estimated to be 20%. The “By Resource Category” graphs show the same information but for specific resource categories (e.g., CPU classes).

A tabular output (not shown) is also available for the preferred embodiment, and consists of four parts. First, a list of the input parameter values for the simulation runs is shown. Second is a table that describes the risk in terms of the maximum number of customers simultaneously requiring disaster recovery. This table has two columns:
1) Number of customers—The number of customers requiring simultaneous recovery during the period specified by the “Time horizon” parameter.
2) Exceedance probability—The probability that the maximum number of simultaneous recoveries will exceed the number in the “# of customers” column.

For example, if a row of the table contains “30 17.1” this means that, over the time horizon specified in the input parameters, the probability that more than 30 customers will simultaneously require disaster recovery is estimated to be 17.1%. The third table gives the same information but for specific resource categories (CPU classes).

The final table lists the accuracies with which different probabilities are estimated. For example, if a row of the table contains “15 0.8” this means that an estimated probability of 15% is accurate to within plus or minus 0.8%, and should be regarded as indicating any value in the range 14.2% to 15.8%.

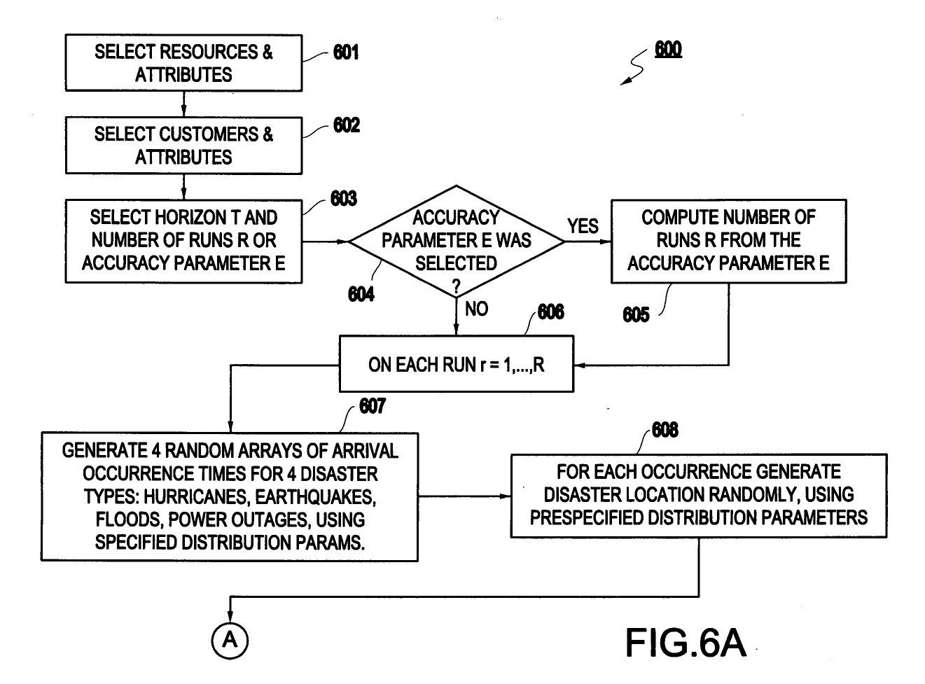

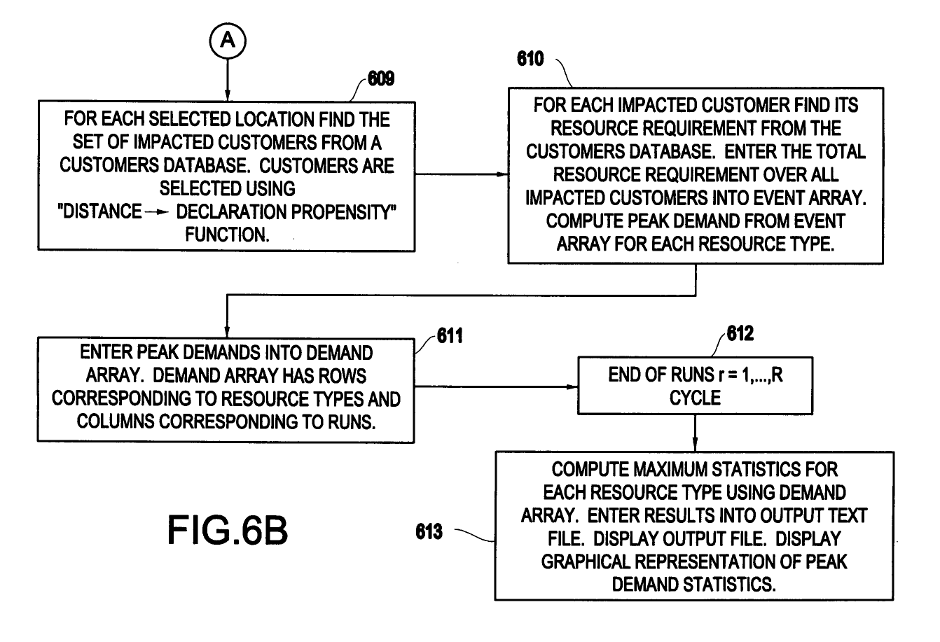

As shown in the flowchart of FIG. 6, operation of the Overall Risk Exposure Tool proceeds as follows:
a. In 601, the user of the tool specifies a set of resources of the disaster recovery service, and their “inventory” attributes. This might be the disaster recovery service's current set of resources (if the current risk of the disaster recovery service is to be assessed), or some hypothetical inventory specifications (to answer the question “what would the disaster recovery service's risks be if its resource inventory were changed to the given levels?”).
b. In 602, the user of the tool specifies a set of customers and their attributes. This might be the disaster recovery service's current set of customers (if the current risk of the disaster recovery service is to be assessed), or some hypothetical set of customers (to answer the question “what would the disaster recovery service's risks be if it had to support this set of customers?”).
c. In 603, the user of the tool specifies a “planning horizon”. This is the length of time covered by the tool's representation of real-world disaster events, and selects whether number of runs R or accuracy parameter E will determine how many runs will be made, as depicted in 604-606.
d. In 607-608, the tool generates a set of disaster event attributes that are in accordance with the patterns of occurrence of disaster events specified in the first of the above-discussed specifications. These events represent a plausible set of disaster events that might occur over the specified planning horizon.
e. In 609-610, for each disaster event generated at step d., the tool generates a set of customers that declare as a result of the event, concordantly with the pattern of customer response to events specified in the second of the above-described specifications.
f. For each customer declaration generated at step e., the tool generates the time of declaration and the time of release, concordantly with the pattern of these times specified in the third of the above-described specifications.
g. In 611, from the record of customer declaration and release times generated at step f., and the customers' resource requirement attributes, the tool computes and stores the maximum number of customers that simultaneously were in the “declared” state, the maximum utilization of each resource during the time horizon, the number of times that a customer could not be recovered because insufficient resources were available, and any other information deemed necessary for risk assessment.
h. As shown in 612, steps d. through g. are repeated a large number of times, say N, using different scenarios of disaster events, and histograms or other representations of the frequency distribution of the risk assessment quantities computed at step g. are accumulated.
i. From the histograms accumulated at step h., the tool computes exceedance probabilities for the risk measures computed at step g. For example, the exceedance probability for M customers simultaneously being in the “declared” state is computed as (the number of simulation runs in which the maximum number of customers simultaneously in the “declared” state was greater than M) divided by N (the total number of simulation runs).

The Overall Risk Exposure Tool also computes estimates of the accuracy of each exceedance probability, in the form of the standard error of the estimated probability. If the estimated probability is p, the standard error of the estimate is computed as the square root of p(1−p)/N.
j. In 613, the exceedance probabilities and their accuracies computed at step i. are the outputs of the tool. They are presented to the user of the tool in tabular or graphical form.

The overall risk exposure and disaster outlooks are calculated for a particular set of disaster recovery service customers. Typically these would be the customers that currently have active contracts. Other possibilities for constructing a customer data file might include using data only for those contracts in a particular geographic area. This enables the risk to be assessed for specified subsets of customers.

The Overall Risk Exposure tool can also answer “what if” questions of the form: “If one hundred new customers are added in Florida, what would the effect be on the maximum demand for resources that the disaster recovery service might experience?” It would provide this assessment, for example, by duplicating some of the entries for a particular geographic area or CPU type.

The simulation runs until a stopping criterion is reached. As selector 402 in FIG. 4 and steps 603-606 of FIG. 6 demonstrate, the user can choose between two criteria. First, “number of runs”, if chosen will cause the program to run until the specified number of simulation runs has been made. Second, “accuracy of estimates”, if chosen will cause the program to run until all of the estimated exceedance probabilities are accurate to approximately the specified value.

The running time of the program is approximately proportional to the number of runs and to the number of customers. The running time increases as the “accuracy of estimates” value is reduced (running time is approximately proportional to the inverse square of the accuracy value).

The data for the disasters statistics are publicly available. For example, the average occurrence rates were exemplarily obtained as follows for various exemplary disaster.

For hurricanes, this is the average number of Atlantic hurricanes (“named storms”) per year. The default value 9.8 is the historical average for 1944-1996, based on data obtained from the National Hurricane Center (NHC).

For earthquakes, the average number per year of earthquakes of magnitude 6 or greater, having epicenters in the continental U.S., or within 50 miles thereof. The default value 0.97 is the historical average for 1930-1989, based on data obtained from the National Earthquake Information Center (NEIC).

For floods, the average number per year is based on the number of federal emergencies due to flooding declared by the Federal Emergency Management Agency (FEMA). The default value 19.2 is the historical average for 1979-1998.

For power outages, the average number per year is based on the number of major disruptions to electric-power transmission networks, as reported by electric utilities to the North American Electric Reliability Council (NERC) under the reporting requirements of the US Department of Energy. The default value 8.5 is the historical average for 1989-1998.

The occurrence rates can be changed to answer “what if” questions such as “how much would the recovery service's risks increase if hurricanes were 50% more frequent than in the past?” Otherwise, they should be left at their default values, which are the best available estimates based on historical data. Clicking the Default button in the Overall Risk Exposure tool window will reset the occurrence rates to their default values.

5. The Disaster Outlook Tool

The Disaster Outlook Tool is a procedure and apparatus that computes risk estimates arising from a particular hypothetical disaster event That is, for a given event, the tool computes the probability that the event will cause any given number of disaster declarations by customers of the disaster recovery service, and any given level of utilization of the various resources. This tool could be used for short-term risk forecasting and resource management.

The tool can be used to predict the likely consequences of a recent or anticipated disaster event. For example, if a hurricane is approaching the east coast, the tool can be used to answer questions such as “If this hurricane makes landfall near ZIP code 28403 (Wilmington, N.C.), how many customer declarations are likely to result from it?”

The probability estimates are based on the same models for the occurrence of disasters as are used by the Overall Risk Exposure tool. However, Disaster Outlook probabilities use a less complex simulation procedure, and the computations are much faster.

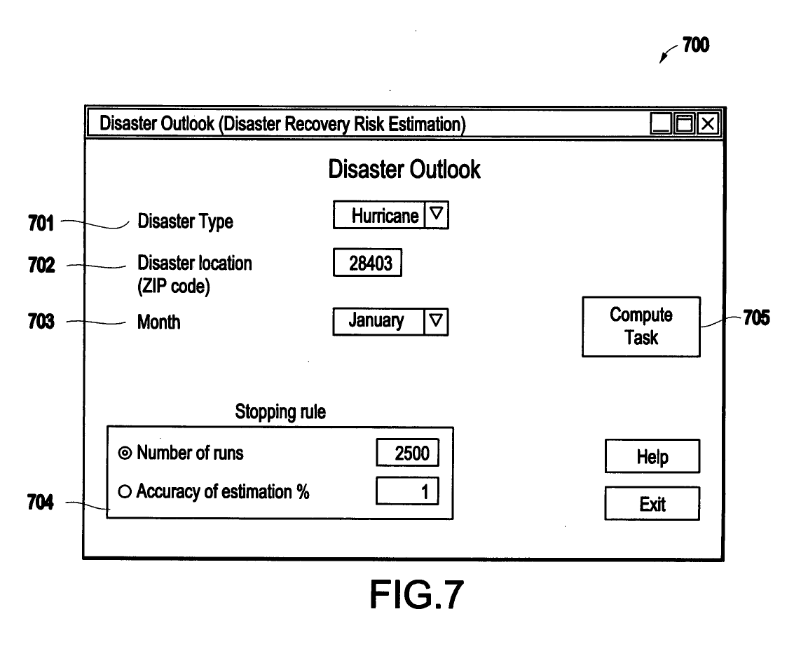

FIG. 7 exemplarily shows the Disaster Outlook screen 700. The user selects a disaster type 701, location 702, month 703, and stopping rule 704, and activates the “compute risk” command 705.

After a disaster type and location is chosen, the tool will construct a hypothetical disaster event, as follows. For a hurricane, the closest location on the east coast of the U.S. to the given ZIP code is found, and a hurricane landfall is assumed to occur at that coast location. If the specified ZIP code is far (more than about 50 miles) from the coast, no risk estimation will be made.

For an earthquake, the hypothesized event is an earthquake of magnitude 6 or greater with epicenter in the given ZIP code. For a flood, the hypothesized event is a flood, centered in the given ZIP code (i.e. the probability of a disaster declaration is greatest for customers in that ZIP code), and of sufficient severity to generate a federal emergency designation. For a power outage, the hypothesized event is a power outage, centered in the given ZIP code (i.e. the probability of a disaster declaration is greatest for customers in that ZIP code), arising from a power supply disruption of sufficient severity to require a report to the North American Electric Reliability Council (NERC).

A month in which the disaster event occurs is also specified. This is relevant only for floods and power outages, whose severity varies according to the time of year. It is noted that hurricane severity varies with time of year, too, but customers' propensity to declare when a hurricane is in their vicinity does not appear to depend on the severity of the hurricane, and is not affected by the time of year that the hurricane occurs.

Output is in both tabular and graphical form. The output is essentially the same as for the Overall Risk Exposure tool.

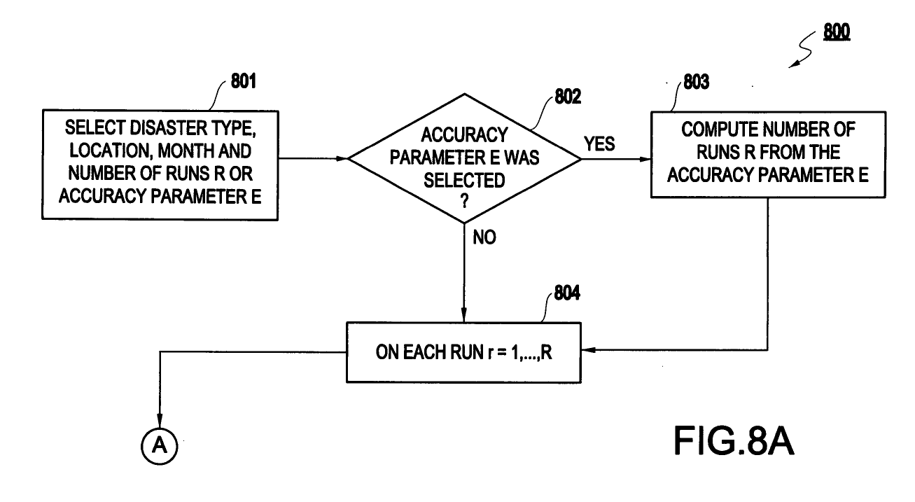

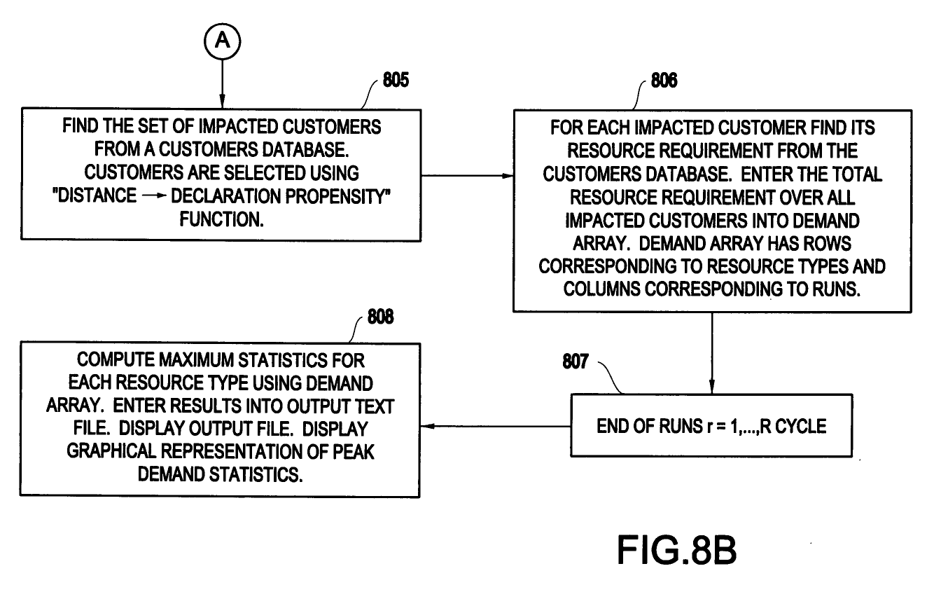

As shown in the flowchart 800 in FIG. 8, the operation of the Disaster Outlook Tool proceeds as follows.
a. In 801, the user of the tool specifies a disaster event and its attributes and whether the number of simulations will be based on accuracy parameter E or number of runs R, as shown in 802-804.
b. The user of the tool can also specify a set of customers and their attributes.
c. For the disaster event specified at step a, in 805-806, the tool generates a set of customers that declare as a result of the event, concordantly with the pattern of customer response to events specified in the second above-discussed specification.
d. For each customer declaration generated at step c, the tool generates the time of declaration and the time of release, concordantly with the pattern of these times specified in the third above-discussed specification.
e. From the record of customer declaration and release times generated at step d, and the customers resource requirement attributes, in 806, the tool computes and stores the total number of customer declarations, the maximum utilization of each resource, and any other information deemed necessary for risk assessment.
f. Steps c through e are repeated a large number of times, say N, as shown in 807, using different scenarios of customer responses to the disaster event, and histograms or other representations of the frequency distribution of the risk assessment quantities computed at step e are accumulated.
g. In 808, from the histograms accumulated at step f, the tool computes exceedance probabilities for the risk measures computed at step e. For example, the exceedance probability for M customers simultaneously being in the “declared” state is computed as (the number of simulation runs in which the maximum number of customers simultaneously in the “declared” state was greater than M) divided by N (the total number of simulation runs).

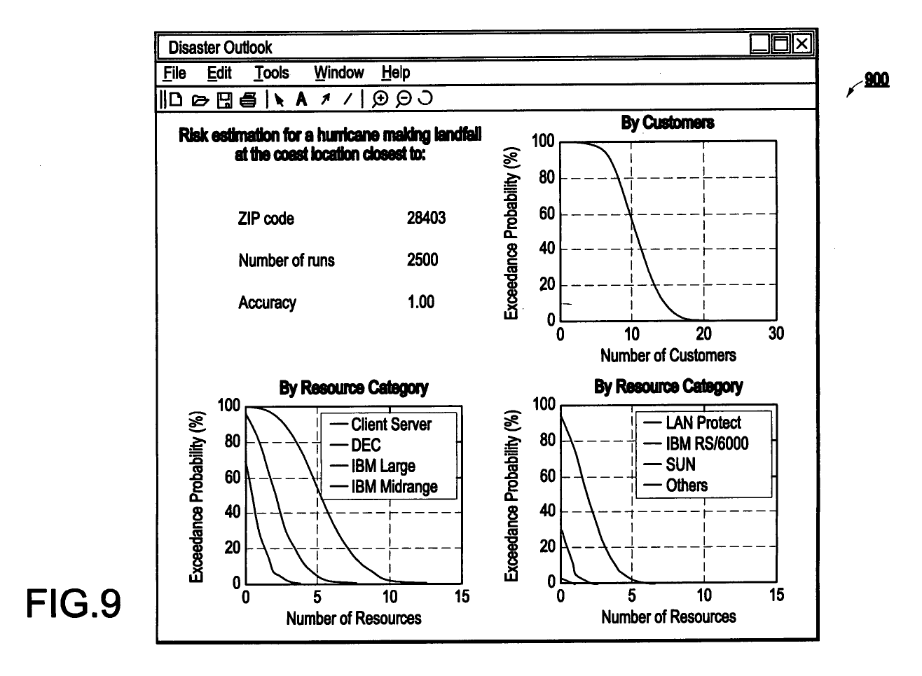

This tool also computes estimates of the accuracy of each exceedance probability, in the form of the standard error of the estimated probability. If the estimated probability is p, the standard error of the estimate is computed as the square root of p(1−p)/N.
h. The exceedance probabilities and their accuracies computed at step g. are the outputs of the tool. In 808, they are presented to the user of the tool in tabular or graphical form, for example, as shown in FIG. 9. This graphical display of FIG. 9 is similar to that discussed for FIG. 5.
   6. The Customer Risk Assessment Tool

The Customer Risk Assessment Tool is a procedure and apparatus that computes the risk exposure of the disaster recovery service's resources due to a single customer, whether actual or potential, and could be used, for example, to assess the profitability of individual contracts.

The risk is measured by an estimate of how frequently, on average, the customer declares a disaster. The degree of risk depends on various attributes of the customer (the customers' “risk factors”), which affect how likely the customer is to be affected by disaster events and how likely the customer is to declare a disaster when a disaster event occurs. The estimated frequency of disaster declaration is based on statistical analysis of the declarations that the disaster recovery has experienced over its history.

The tool uses the frequency and patterns of occurrence of each type of disaster event from the first above-discussed specification. This specification is stored as a machine representation of statistical models, for each type t of disaster event, of p_t(e), the probability of occurrence, within a specified time horizon that is exemplarily taken to be one year, of a disaster event of type t and event attributes (other than event type) described by the vector e.

The tool also uses the second above-discussed specification for the relation between the occurrence of a disaster event and the number of customer declarations that it causes. This specification is stored as a machine representation of statistical models, for each type t of disaster event, of d_t(c,e), the probability that a customer with attributes described by the vector c will declare given that a disaster of type t occurs that has attributes (other than event type) described by the vector e.

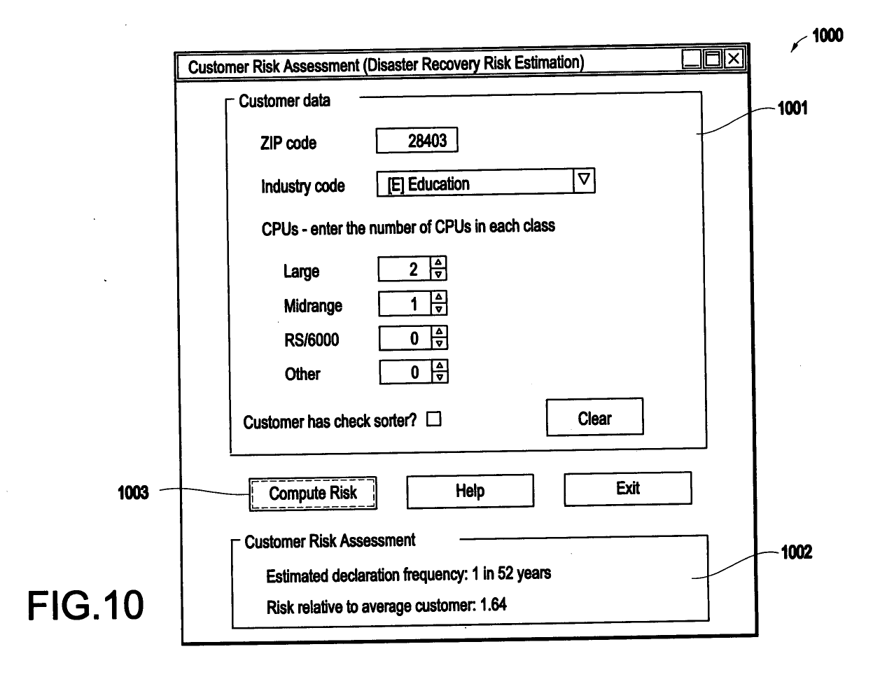

FIG. 10 exemplarily shows an exemplary Customer Risk Assessment tool screen 1000. It is noted that this third tool, unlike the first two tools, does not run simulations. Rather, it calculates a result based on an underlying statistical model. Customer data 1001 is entered, and the result 1002 is displayed after having activated the “compute risk” command 1003.

For example, the input parameter for customer location ZIP code is entered, followed by the industry code chosen from a listing. Customers in some industries have a greater propensity to declare a disaster when a disaster event affects them. For example, the travel and transportation and finance industries particularly show this effect.

In the example for disaster recovery for a computer, the number of CPUs that the customer has in each of the four broad classes indicated is entered. Next, the check box, if the customer has a check sorter, is marked. Check sorters seem particularly liable to fail, and having one significantly increases the chance that a customer will declare a disaster.

Results are displayed in the “Customer Risk Assessment” panel at the bottom of the window. The output is the estimated frequency with which the customer will declare a disaster, expressed as “1 in X years”. This number is also given as a ratio of the historical average rate of customer declarations experienced by the disaster recovery service over its history, this historical average rate being 1 in 85 years.

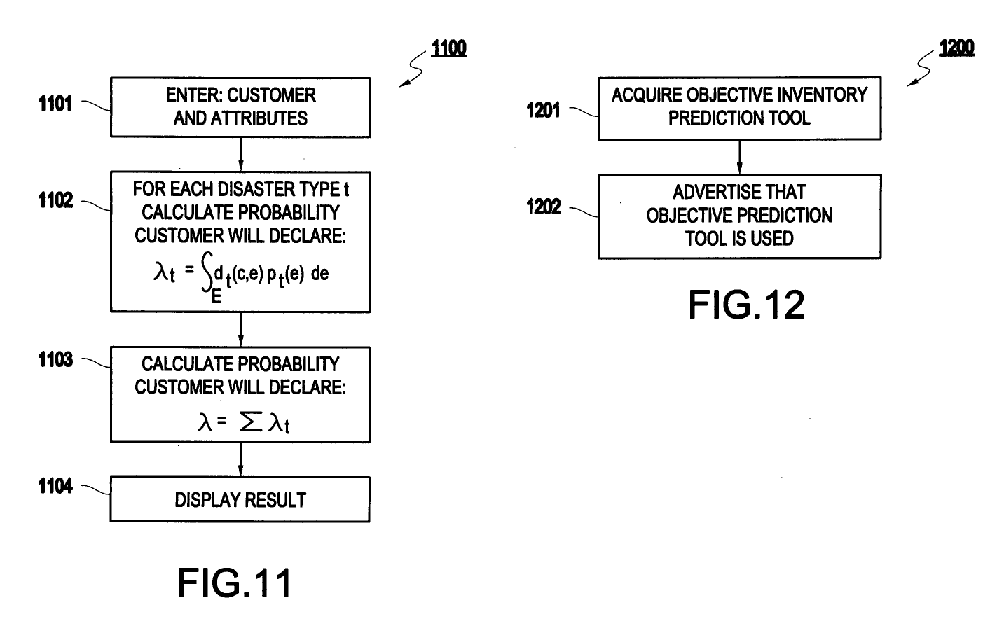

As shown in the flowchart 1100 of FIG. 11, operation of the Customer Risk Assessment Tool proceeds as follows.
a. In 1101, the user of the tool specifies a customer, actual or potential, and its attributes.
b. For each type t of disaster event, the tool in 1102 computes the probability that the customer will declare, as a result of a disaster of type t occurring during the time horizon. This probability is defined by
   λₜ∫_{E}dₜ(c, e)ₜ(e)de
   where E is the set of all possible event magnitudes. The probability is exemplarily computed by numerical integration.
c. The tool computes in 1103 the probability that the customer will declare during the time horizon. This probability is the sum of the type-specific probabilities λₜ, and is computed as

$$λ = {\sum }_{t} {λ}_{t}$$
d. The probabilities λ and λₜ, and their reciprocals, the average time intervals between declarations, are the outputs of the tool. In 1104, these results are printed or displayed on the computer screen.
   Commercial Advantage of the Present Invention

It should be apparent that access to the present invention provides a potentially valuable tool for such enterprises as a disaster recovery service. As shown in FIG. 12, is such access 1201 is available, this tool provides a commercial advantage in that the enterprise would be able to advertise 1202 that it uses an objective, realistic method of maintaining an inventory. As previously mentioned, no such objective inventory method currently exists for the disaster recovery service industry, and such objective inventory method would greatly increase customer confidence.

There are various ways in which an entity using the present invention could benefit. For example, the risk against real inventory and the sum of all contracts can be assessed. Different costs can be allocated to contracts as a result of knowing the probability of a disaster in particular areas. There is a commercial advantage in simply knowing the probability of a disaster. If, for example, an entity could begin to assess asset requirements days before a hurricane makes land and begin to locate predicted needed resources to lower exposure upon landfall. And, since the tool could be used to assess risk associated with customer locations, price point differentials could be offered to customers located outside high-risk disaster areas.

The Disaster Models

To demonstrate how disaster models can be developed for use in the present invention, two exemplary disaster models are now discussed in some detail and a third model is briefly mentioned. It should be apparent that similar models could be developed for other disaster types after having read these two examples.

The Hurricane Model

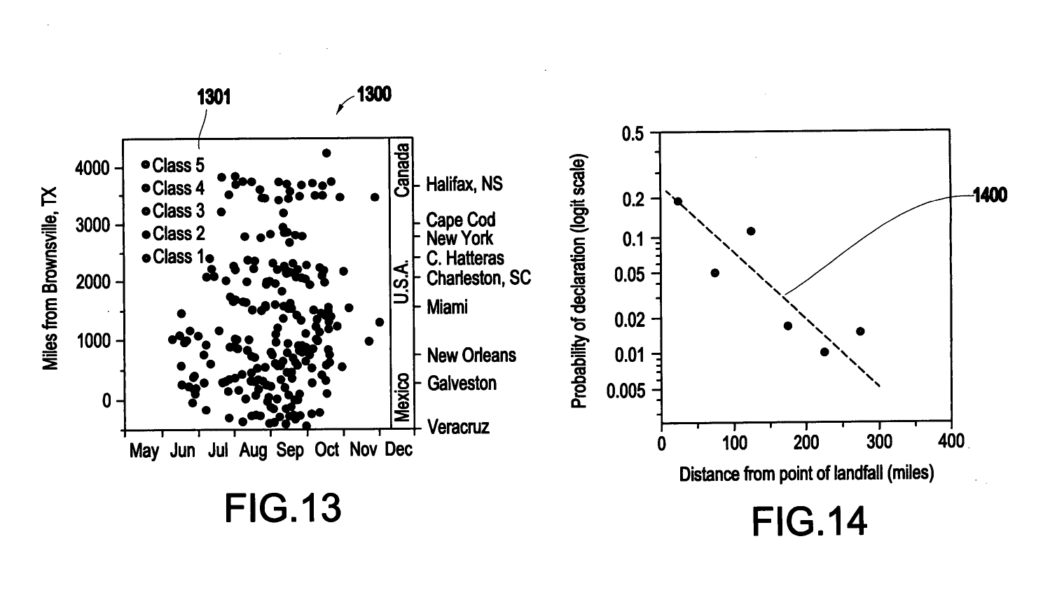

As exemplarily demonstrated by FIG. 13, a hurricane model is based on hurricane landfalls 1300 on a section of the eastern coast of North America from Veracruz, Mexico, to Newfoundland. The model uses only hurricane landfall, rather than the entire track, primarily because there is insufficient data on disaster declarations to permit accurate calibration of customers' response to all of the identifiable features of an entire hurricane track. According to the data used for the exemplary embodiment of the present invention, the average frequency of hurricane landfalls on this section of coast is 1.97 per year.

Landfall frequency varies with time of year and the location on the coast. It is taken to be piecewise constant on time segments, e.g., 30, and coast segments, e.g., 68. The frequencies are estimated from the actual counts of hurricane landfalls in each time and space segment, with some smoothing to give a realistically smooth variation of frequency with space and time.

Severity 1301 of a hurricane can be measured, for example, by its maximum sustained wind speed at time of landfall, in knots. This is a random quantity that is assumed distributed independently of time and location of landfall. The distribution was estimated by fitting to the NHC historical data. The estimated distribution is generalized Pareto (J. R. M. Hosking and J. R. Wallis, “Parameter and quantile estimation for the generalized Pareto distribution”, Technometrics, 1987, vol. 29, pp. 339-349) with parameters ξ=65. α=25, k=0.25 (lower bound 65, mean 85, upper bound 165).

When a hurricane landfall occurs, customers declare (their declarations are presumed to be statistically independent) with a probability that is a function of the distance from the customer location to the point of landfall. Let D be this distance in miles.

$$Probability ( customer declares ) = \{ \begin{matrix}1 / ( 1 + exp ( a + bD ) & if D \leq 300 \\ 0 & if D > 300\end{matrix}$$

As shown in FIG. 14, the a and b values give, an approximate fit 1400 to the disaster recovery service's historical data on customer declarations.

Given that a customer declares, the time delay between landfall and declaration is a random quantity. From the historical data, it is judged to have an exponential distribution with a mean that can be readily calculated, and the duration of the declaration is judged to be exponentially distributed with mean that is also readily calculated.

To implement this model, i.e., generate a sequence of hurricane events, one possible sequence could be as follows.
(1) Generate the arrival time (in years) on a transformed time axis on which events are uniformly distributed. That is, the inter-arrival times are independent and exponentially distributed with mean 1/1.97.
(2) Convert the arrival time to “real time” by taking the fractional part of the arrival time by linear interpolation.
(3) Generate the epicenter (point of landfall):
   (3.1) Generate U₁ uniform on (0,1);
   (3.2) Find this U₁ value by linear interpolation of a “coast table”;
   (3.3) Do the corresponding interpolation to get the latitude and longitude of the point of landfall.
(4) Generate the severity, S, from the generalized Pareto distribution:
   (4.1) Generate U₂ uniform on (0,1);
   (4.2) Set ξ=+(α/k)(1−U^{k}₂).
      The Earthquake Model

Earthquake occurrences in the continental U.S.A. are modeled. It is assumed that earthquakes occur independently, with a rate that is constant over time but varies with geographic location. This is modeled by assuming that earthquake epicenters occur according to a Poisson process in time and two-dimensional space; the rate of the Poisson process is constant over time but varies over space.

The severity of an earthquake event can be measured, for example, by its magnitude on the Richter scale, denoted by M. It is assumed that the severity of an event is independent of the location of the epicenter, i.e., that the relative frequencies of earthquakes of different magnitudes are the same at all locations regardless of their overall earthquake frequency. This simple model seems consistent with current seismological knowledge.

Earthquakes severe enough to cause a declaration by a customer are modeled. This threshold of severity is taken, exemplarily, to be magnitude M=5.5, for reasons explained below. The frequency of such earthquakes in the continental U.S. is estimated to be 2.52 per year.

Earthquake frequency as a function of geographic location is estimated for each 1⁰ grid square of latitude and longitude, by counting the number of earthquakes of magnitude M≧4 that occurred in each grid square in the period 1990-97. This is a fairly crude estimate, but is sufficient for explaining the present invention.

The distribution of earthquake severity (magnitude) was fitted to the NEIC data. For threshold M=5.5, the distribution is generalized Pareto with parameters ξ=5.5, α=0.55, k=0.10. This distribution can give magnitudes as high as 11, an unreasonably large number, so the largest magnitudes are transformed so as to be less than 9, a more realistic upper bound. The transformation is

$$M trans = \{ \begin{matrix}M & if M \leq 8 \\ 9 - exp \{ p ( M - 8 ) \} & if M > 8\end{matrix}$$

When an earthquake of magnitude M occurs, customers declare (their declarations are assumed to be statistically independent) with a probability that is a function of the distance from the customer location to the epicenter of the earthquake. Let D be this distance, in miles.

$$Probability ( customer declares ) = \{ \begin{matrix}1 / ( 1 + exp ( a + bD ) & if D \leq 40 ( M - 5.5 ) \\ 0 & if D > 40 ( M - 5.5 )\end{matrix}$$

where the a and b values give an approximate fit to the disaster recovery service's historical data on customer declarations. In the model, it is assumed that, given that a customer declares, the time delay between earthquake occurrence and customer declaration is exponentially distributed with mean that can be readily calculated from the data available from the disaster recovery service historical records and that the duration of the declaration is exponentially distributed with mean also readily calculated from these records.

To implement this model, i.e., generate a sequence of earthquake events (time, epicenter, severity), one possible sequence could be as follows.

(1) Generate arrival time: interarrival times are independent and exponentially distributed with mean 1/2.52.
(2) Generate epicenter.
   (2.1) Generate U₁ uniform on (0,1).
   (2:2) From an earthquake data file, find the first entry that is larger than this U₁ value
   (2.3) Locate the latitude φ, and longitude θ of the SE corner of the grid square containing the epicenter of this earthquake.
   (2.4) Generate U₂ and U₃ uniform on (0,1).
   (2.5) Latitude and longitude of epicenter are φ+U2, θ+U₃, respectively.
(3) Generate magnitude.
   (3.1) Generate U₄ uniform on (0,1).
   (3.2) Generate magnitude from Pareto distribution: set M=ξ+(αt/k)(1−U^{k}₄).
   (3.3) If M>8, replace M by 9—exp{−(M−8)}.
      The Flood Model

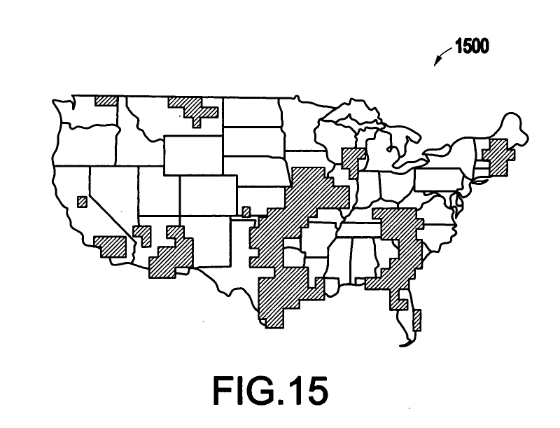

Details of the flood model used in the present invention are straight forward from the two examples above, as could be based on data such as shown in FIG. 15, which shows in graphic format 1500 an exemplary distribution of flood region centers for October. The model as implemented assumes a Poisson process having a rate that depends on location and month. The size of the flooding was assumed random, with a diameter modeled by a gamma distribution.

The probability that a specific customer would declare is assumed to be a first, higher, probability if the customer is located in a “susceptible county” and a second, lower, probability if the customer is located outside a “susceptible county”. The duration of the declaration is assumed as exponential, having a mean period that is readily calculated from historical data of the disaster recovery service.

Exemplary Hardware Implementation

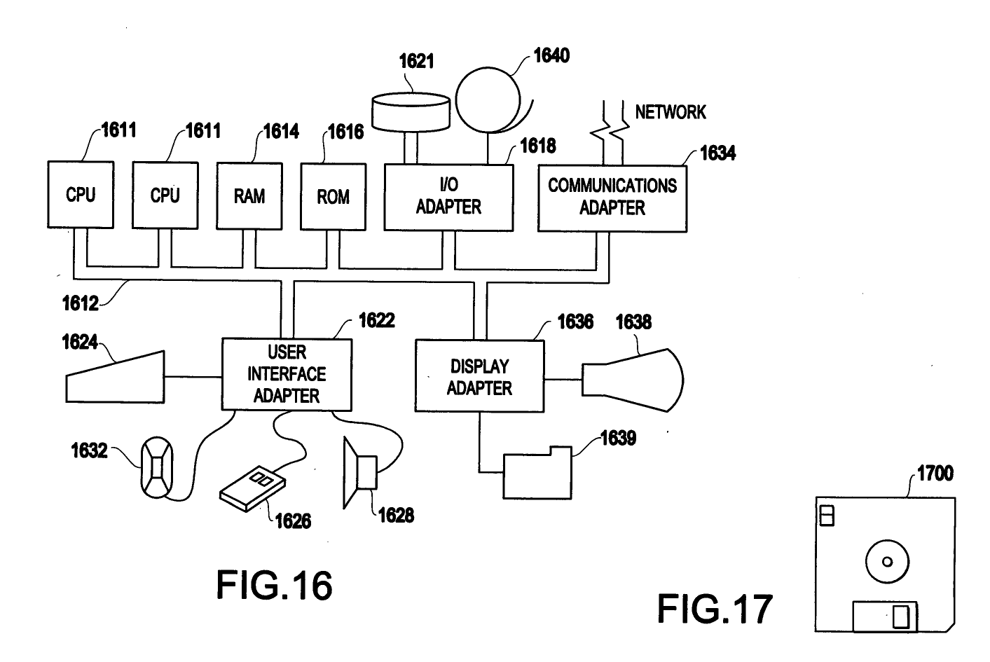

FIG. 16 illustrates a typical hardware configuration of an information handling/computer system in accordance with the invention and which preferably has at least one processor or central processing unit (CPU) 1611.

The CPUs 1611 are interconnected via a system bus 1612 to a random access memory (RAM) 1614, read-only memory (ROM) 1616, input/output (I/O) adapter 1618 (for connecting peripheral devices such as disk units 1621 and tape drives 1640 to the bus 1612), user interface adapter 1622 (for connecting a keyboard 1624, mouse 1626, speaker 1628, microphone 1632, and/or other user interface device to the bus 1612), a communication adapter 1634 for connecting an information handling system to a data processing network, the Internet, an Intranet, a personal area network (PAN), etc., and a display adapter 1636 for connecting the bus 1612 to a display device 1638 and/or printer 1639 (e.g., a digital printer of the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 1611 and hardware above, to perform the method of the invention.

This signal-bearing media may include, for example, a RAM contained within the CPU 1611, as represented by the fast-access storage for example. Alternatively, the instructions may be contained in another signal-bearing media, such as a magnetic data storage diskette 1700 (FIG. 17), directly or indirectly accessible by the CPU 1611.

Whether contained in the diskette 1700, the computer/CPU 1611, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

As described in the exemplary embodiment, the present invention provides a systematic and objective method for risk estimation for a disaster recovery business. It provides objective criteria by which the business may: set inventory levels at its recovery centers, plan the location of its recovery centers, decide whether anticipated changes in the rates of occurrence of disaster events will adversely affect the business, judge whether its current resources are sufficient to deal with an anticipated increase in the number of customers; judge whether its current resources are sufficient to deal with a specific (actual or potential) disaster event; decide whether individual (actual or potential) contracts are profitable.

The improvements to the business's ability to manage disaster events consequent upon the business's use of the invention may be expected to lead to greater levels of satisfaction among the business's customers.

The business will be able to use in its advertising the fact that it has a systematic and objective method for risk estimation, and may thereby expect to obtain an advantage over competing businesses that are unable to make such a claim.

The invention (or parts of it, or something similar to it) may be applied to any operation that is subject to interruption by external events and for which the reaction to those events is not predetermined. This aspect of the present invention differentiates it from superficially similar applications in insurance, where the reaction to a valid claim by the customer is typically a fixed payout.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

1. A method of calculating a risk exposure for a disaster recovery process, said method comprising:
loading a user interface into a memory, said user interface allowing control of an execution of one or more risk models, each said risk model being based on a specific disaster type, each said risk model addressing a recovery utilization of one or more specific assets identified as necessary for a recovery process of said disaster type; and
executing, at least one time, one of said risk models.

2. The method of claim 1, further comprising:
loading at least one of said risk models into one of a local computer memory and a local memory of a computer at a remote location, said loading allowing said executing of said model.

3. The method of claim 1, wherein at least one of said risk models is based on a Poisson distribution function.

4. The method of claim 1, wherein said specific disaster type comprises at least one of a:
hurricane;
earthquake;
flood; and
power outage.

5. The method o'f claim 1, wherein said risk models include at least one of:
an overall risk exposure that assess a risk that said one or more specific assets will be adequate to recover from said disaster;
a disaster outlook to assess a consequence of a recent or anticipated disaster at a specific location; and
a customer risk assessment to access a risk for an individual customer.

6. The method of claim 1, wherein each said risk model includes at least one parameter selectable in a random manner.

7. The method of claim 2, wherein at least one of said GUI and said risk models are stored in a remote computer and said loading comprises a transfer of at least said GUI to a local computer.

8. The method of claim 6, further comprising:
executing said model a number of times, each execution based on a random setting of at least one said parameter selectable in a random manner.

9. The method of claim 8, wherein said number of times is established by at least one of:
entering a number of runs to be executed; and
entering an accuracy of a result, said accuracy causing said model to be executed repeatedly until said accuracy is attained.

10. An apparatus configured to calculate a risk exposure for a disaster recovery process, said apparatus comprising:
a user interface allowing control of an execution of one or more risk models, each said risk model being based on a specific disaster type, each said risk model addressing a recovery utilization of one or more specific assets identified as necessary for a recovery process of said disaster type; and
an execution command switch for commanding an execution of at least one of said risk models.

11. A network configured to calculate a risk exposure for a disaster recovery process, said network comprising at least one of:
a first computer having:
a user interface allowing control of an execution of one or more risk models, each said risk model being based on a specific disaster type, each said risk model addressing a recovery utilization of one or more specific assets identified as necessary for a recovery process of said disaster type; and
an execution command switch for commanding an execution of at least one of said risk models; and
a second computer having a memory storing at least one of said risk models.

12. A signal-bearing medium tangibly embodying a program of machine-readable instructions executable by a digital processing apparatus to perform a method of calculating a risk exposure for a disaster recovery process, said method comprising:
loading a user interface into a memory, said user interface allowing control of an execution of one or more risk models, each said risk model being based on a specific disaster type, each said risk model addressing a recovery utilization of one or more specific assets identified as necessary for a recovery process of said disaster type; and
executing, at least one time, one of said risk models.

13. A method of objectively quantifying consequences of an event, said method comprising:
loading one or more models concerning said event into a memory, at least one of said models predicting a consequence of said event, said predicting based on an historical data of said event;
executing at least one of said risk models a plurality of times, each time using at least one parameter that is selected at random; and
using a result of said executing to quantify a probability of a consequence of said event.

14. The method of claim 13, wherein said event comprises a disaster.

15. The method of claim 14, wherein said consequence comprises a utilization of resources provided by a disaster recovery service.

16. The method of claim 15, wherein said resources comprise at least one of a use of a computer and a use of a computer-related component.

17. The method of claim 13, wherein at least one of said models is based on a probability function having parameters approximating an historical data of the occurrence of said event.

18. A signal-bearing medium tangibly embodying a program of machine-readable instructions executable by a digital processing apparatus to perform a method of method of objectively quantifying consequences of an event, said method comprising:
loading one or more models concerning said event into a memory, at least one of said models being based on predicting a consequence of said event, as based on an historical data of said event;
executing at least one of said risk models a plurality of times, each time using at least one parameter that is selected at random; and
using a result of said executing to quantify a probability of a consequence of said event.

19. The method of claim 18, wherein at least one of said models is based on a probability function having parameters approximating an historical data of the occurrence of said event.

20. A method of operating a disaster recovery service, said method comprising:
acquiring access to a tool that calculates a risk exposure for a disaster recovery process, said tool having one or more risk models, each said risk model being based on a specific disaster type, each said risk model addressing a recovery utilization of one or more specific assets identified as necessary for a recovery process of said disaster type; and
advertising that said disaster recovery service utilizes said tool as a technique to control an inventory of said assets.

21. The method of operating a disaster recovery service of claim 0.20, further comprising at least one of the following:
assessing a risk against a real inventory and a sum of all contracts;
allocating a cost of a contract as a result of calculating a probability of a disaster in a location;
assessing an asset requirement before a predicted disaster actually strikes a location;
locating assets to overcome a predicted asset shortage based on a prediction of occurrence of a disaster; and
offering price point differentials to customers located outside a high-risk disaster area.
